(19) United States
(12) Patent Application Publication
(10) Pub. No.: US 2026/0320912 A1
(43) Pub. Date: Oct. 15, 2026

(54) Machine Learning Calibration for Providing Media Content

(71) Applicant: Spotify AB, Stockholm (SE)

(72) Inventors: Sanket Gupta, Ridgewood, NJ (US); Diego Feijer, Marina del Rey, CA (US); Todd Wasson, Livermore, CA (US); Alex Clare, New York, NY (US)

(21) Appl. No.: 19/211,895

(22) Filed: May 19, 2025

Related U.S. Application Data
(60) Provisional application No. 63/788,901, filed on Apr. 15, 2025.

(51) Int. Cl. G06T 17/00

(52) U.S. Cl. CPC G06T 17/00

(57) ABSTRACT

An example embodiment may involve: determining a plurality of virtual shelf compositions, wherein each of the virtual shelf compositions represents a different distribution of content between at least a first content type and a second content type; determining, for each of the virtual shelf compositions, likelihoods of user engagements with any of the content thereon; selecting, from the plurality of virtual shelf compositions, a virtual shelf composition that has a highest of the likelihoods, wherein the virtual shelf composition has a distribution of content; tuning the distribution of content for the virtual shelf composition based on an exploration process; filling, in accordance with the distribution of content as tuned, the virtual shelf composition with a set of content of at least the first content type and the second content type; and providing, for display on an electronic device, a representation of the virtual shelf composition as filled.

### CROSS-REFERENCE TO RELATED APPLICATION

This application claims priority to U.S. provisional patent application no. 63/788,901, filed Apr. 15, 2025, which is hereby incorporated by reference in its entirety.

### FIELD OF THE INVENTION

The present invention relates to the field of media content item streaming. Specifically, it pertains to methods, systems, and devices that facilitate machine learning calibration for providing media content.

### BACKGROUND

Media recommendation systems determine suggested media content items (e.g., audio and/or video content including songs, podcast episodes, videos, and/or audiobooks) from a catalog thereof for presentation (e.g., streaming and/or download) to users. This presentation may be in the form of a suggestion of one or more media content items for display on a user interface or population within a proposed playlist. The users may select to consume (e.g., play out audibly and/or visually) some, all, or none of any of these suggestions.

### SUMMARY

A media delivery environment (e.g., providing streamed and/or downloaded media content) may include at least millions of users and tens of millions of media content items (optionally referred to as “content”). Selecting media content items to present to users in such an environment may involve complex algorithms that are computationally expensive to execute. Even so, the selected media content items may be presented in a manner that lacks context and therefore may be overlooked by the users.

This problem is exacerbated by the tendency for many users to engage with and/or consume mainly one type of media content item. For example, historical data for a user may indicate that the user spends 95% of their consumption time listening to music (e.g., songs), with the remaining 5% of this time split between podcasts and audiobooks. If a media recommendation system uses a naïve approach when populating a presentation of suggested media content items for the user, such an approach may determine-from this historical data-that the user is likely to prefer almost any music content item over almost any podcast or audiobook. Thus, the system could recommend music 100% of the time and no podcasts or audiobooks. In other words, the system might always suggest the majority type because that will provide the highest prediction accuracy.

This outcome could exhibit a bias in the system, in that some content types (e.g., podcasts and audiobooks) might be effectively underrepresented in the recommendations. It also is at odds with the understanding that heavy users of one type of media content item might actually enjoy other types of media content items, should the system facilitate discovery of these other types of media content items for the user. Thus, the system may actually provide better recommendations by enhancing discovery of the user's less popular media content types.

Various implementations disclosed herein involve a media recommendation system for suggesting media content items to users of a media delivery system. The media recommendation system could present these recommendations to the user on a web page or page of an application, in a playlist, as search results, or in some other format. A goal of the recommendation system is to make it so that the number of total recommended media content items is split between media content types (e.g., music, podcasts, videos, and audiobooks) in a manner that reflects the user's preferences for these types but also facilitates discovery of new and relevant content for the user. In some cases, the split may be between different content characteristics and not just types.

More accurate recommendation systems are inherent technical improvements over less accurate recommendation systems because they use fewer computational resources (e.g., processing, memory, network, and/or power capacity). This is at least in part due to users being more likely to accept their recommendations, and therefore recommendation determinations need to be executed less frequently.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes determining a plurality of virtual shelf compositions, where each of the virtual shelf compositions represents a different distribution of content between at least a first content type and a second content type. The method also includes determining, for each of the virtual shelf compositions, respective likelihoods of one or more user engagements with any of the content thereon. The method also includes selecting, from the plurality of virtual shelf compositions, a virtual shelf composition that has a highest of the respective likelihoods, where the virtual shelf composition has a respective distribution of content. The method also includes tuning the respective distribution of content for the virtual shelf composition based on an exploration process. The method also includes filling, in accordance with the respective distribution of content as tuned, the virtual shelf composition with a set of content of at least the first content type and the second content type. The method also includes providing, for display on an electronic device, a representation of the virtual shelf composition as filled. Other embodiments of this aspect include corresponding computer systems, apparatus, and computer programs recorded on one or more computer storage devices, each configured to perform the actions of the methods.

One general aspect includes determining a virtual shelf composition representing a distribution of content between a first content type and a second content type. The method also includes tuning the distribution of the virtual shelf composition based on an exploration process. The method also includes filling, in accordance with the distribution as tuned, the virtual shelf composition with a set of content of at least the first content type and the second content type. The method also includes providing, for display on an electronic device, a representation of the virtual shelf composition as filled. Other embodiments of this aspect include corresponding computer systems, apparatus, and computer programs recorded on one or more computer storage devices, each configured to perform the actions of the methods.

One general aspect includes determining a plurality of virtual shelf compositions, where each of the virtual shelf compositions represents a different distribution of content between at least a first content type and a second content type. The method also includes determining, for each of the virtual shelf compositions, respective likelihoods of one or more user engagements with any of the content thereon. The method also includes selecting, from the plurality of virtual shelf compositions, a virtual shelf composition that has a highest of the respective likelihoods, where the virtual shelf composition has a respective distribution of content. The method also includes filling, in accordance with the respective distribution, the virtual shelf composition with a set of content of at least the first content type and the second content type. The method also includes providing, for display on an electronic device, a representation of the virtual shelf composition as filled. Other embodiments of this aspect include corresponding computer systems, apparatus, and computer programs recorded on one or more computer storage devices, each configured to perform the actions of the methods.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 is a block diagram illustrating a media content delivery system, in accordance with example embodiments.

FIG. 2 is a block diagram illustrating an electronic device, in accordance with example embodiments.

FIG. 3 is a block diagram illustrating a media content server, in accordance with example embodiments.

FIG. 4A depicts a media content recommendation system, in accordance with example embodiments.

FIG. 4B depicts another media content recommendation system, in accordance with example embodiments.

FIG. 5 is a flow chart, in accordance with example embodiments.

FIG. 6 is a flow chart, in accordance with example embodiments.

FIG. 7 is a flow chart, in accordance with example embodiments.

### DETAILED DESCRIPTION

Example methods, devices, and systems are described herein. It should be understood that the word “example” or “exemplary” to the extent used herein means “serving as a possible instance or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, any separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Still further, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

In addition, unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### I. Example System and Device Architecture

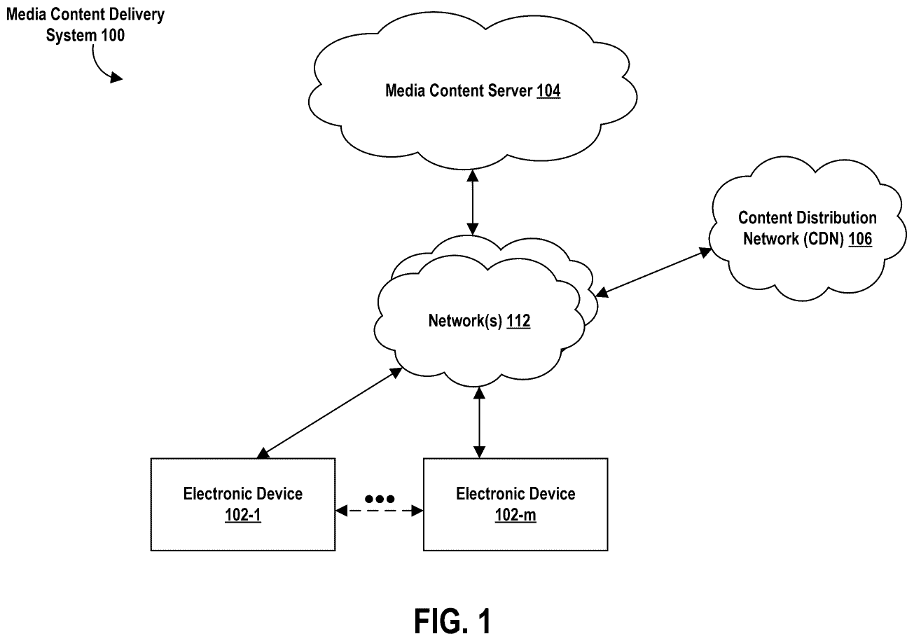

FIG. 1 is a simplified block diagram illustrating an example media content delivery system 100. The example media content delivery system 100 includes one or more electronic devices 102 (e.g., electronic device 102-1 to electronic device 102-m, where m is an integer greater than one), at least one media content server 104, and at least one content distribution network (CDN) 106. With this arrangement, the media content server 104 may be configured to stream or otherwise provide media content items, possibly through the CDN 106, for receipt and playout by the electronic devices 102.

Media content items (also referred to as “media content”, “content”, “media items”, and “content items”) may take various forms. For instance, the media content items may include audio (e.g., music, spoken word, podcasts, audiobooks, etc.), video (e.g., short-form videos, music videos, videos from podcasts, television shows, movies, clips, previews, etc.), text (e.g., articles, blog posts, emails, etc.), image data (e.g., image files, photographs, drawings, renderings, etc.), games (e.g., 2D or 3D graphics-based computer games, etc.), web pages, and/or any combination of these and/or other types of content. In some embodiments, media content items may include one or more audio media content items, such as particular songs, podcasts, or audiobooks, that may be referred to as “audio items,” “tracks,” and/or “audio tracks”.

As shown, one or more networks 112 may communicatively couple the components of the media content delivery system 100. The one or more networks 112 may include public communication networks, private communication networks, or a combination of both public and private communication networks. For example, the one or more networks 112 could include one or more wide area networks (WANs) such as the Internet, a cellular network, and a satellite communication network, and/or could include one or more local area networks (LAN), virtual private networks (VPN), metropolitan area networks (MAN), peer-to-peer networks, mesh networks, and/or ad-hoc connections, among other possibilities.

Example electronic devices 102, which may be associated respectively with one or more users, may take various forms. For instance, an electronic device 102 could be a personal computer, a mobile electronic device, a wearable computing device, a laptop computer, a tablet computer, a mobile phone, a feature phone, a smartphone, an infotainment system, a digital media player, a gaming device, a speaker, a television (TV), and/or any other electronic device capable of playing and/or presenting media content (e.g., controlling playback of media items, such as music tracks, podcasts, videos, etc.) Alternatively, the electronic device 102 may be a component of another system such as a home entertainment system, a radio/alarm clock, or an infotainment system of a vehicle, for instance, and may enable that system to play media content.

In some embodiments, the electronic devices 102 may be the same type of device as each other (e.g., electronic device 102-1 and electronic device 102-m are both speakers). In other embodiments, the electronic devices 102 may include two or more different types of devices.

The example electronic devices 102 may also be configured to communicate with each other through direct or networked communication links, represented by the dashed arrow in FIG. 1, which may include wireless and/or wired connections. For instance, the electronic devices 102 may communicate with each other through a direct wired connection such as a High Definition Multimedia Interface (HDMI) connection, or through a direct wireless communication such as short or medium range wireless signaling using technologies such as BLUETOOTH, BLUETOOTH LOW ENERGY (BLE), ZIGBEE, WI-FI, WIRELESSHART, Near Field Communication (NFC), Radio Frequency Identification (RFID), infrared, Thread, Z-Wave, MiWi, Low-Rate Wireless Personal Area Network (LR-WPAN), or Internet Protocol v. 6(IPv6 ) over WPAN (6oWPAN), among other possibilities. Alternatively or additionally, the electronic devices 102 may communicate with each other through one or more networks (perhaps one or more of network(s) 112), such as through a wireless mesh network, a LAN, a cellular network, or other form of network. Through these inter-device connections, one electronic device 102-1 may stream or otherwise transmit media content to another electronic device 102-m to facilitate playout of the media content.

An example electronic device 102 may be configured to play media content items, outputting the associated media content for presentation to a user and/or outputting the associated media content through an inter-device connection to another electronic device for presentation to a user.

The electronic device 102 may obtain these media content items from local data storage and/or through transmission from the media content server 104, CDN 106, or other device or system. For instance, the electronic device 102 may include or otherwise have access to local data storage containing some of these media content items and may be configured to retrieve the media content items from that local data storage and to play out the retrieved media content items. Further the electronic device 102 may be configured to interwork with the media content server 104 to cause the media content server 104 to stream, progressively download, and/or otherwise transmit media content items to the electronic device 102, and the electronic device 102 may be configured to receive and play out those transmitted media content items as well. In some cases, an example electronic device 102 may also be configured to transmit to the media content server 104 indications of media content items, possibly the media content items themselves, for various purposes.

To facilitate playout of media content items, the example electronic device 102 may be programmed with a media application. The media application may provide a user interface (e.g., a graphical user interface (GUI)) through which a user of the electronic device 102 can control playing of media content items, and the media application may include a media-playback engine configured to obtain and play out media content items in response to user control commands and/or other triggers.

For instance, the media application may receive a user's control commands related to playout of media content items, such as requests to play particular media content items or playlists of media content items and commands to pause or stop media playout, to adjust volume, or to jump to a next track or a previous track, among other possibilities. And the media application may be configured to respond to those commands by engaging in associated control signaling with the media content server 104 to control streaming or other transmission of media content items from the media content server 104 to the electronic device 102 and/or by engaging in associated control of playing out media content items from local data storage.

An example media content server 104 may be configured to receive media commands or other requests from electronic devices 102 and to respond accordingly. To facilitate this, in some embodiments, the media content server 104 may provide an application programming interface (API), such as a voice API or a connect API, accessible by one or more of the electronic devices 102. The media content server 104 may also be configured to validate (e.g., authenticate) electronic devices 102 using a key service, such as by exchanging one or more keys (e.g., tokens) with the electronic device 102.

The example media content server 104 may include or otherwise have access to data storage storing media content items available for transmission to electronic devices 102, as well as playlists each defining a sequence or other set of media content items for playout. Playlists may be defined by users of the electronic devices 102, by editors associated with media-providing services, and/or by machine-based processes, among other possibilities. The media content server 104 may also be configured to provide electronic devices 102 with information about the available media content items and playlists, such as web pages or other interfaces presenting the information, to enable users of the electronic devices 102 to obtain this information and to correspondingly control media playout.

Further, in some implementations, the media content server 104 may interwork with the one or more CDNs 106 to facilitate management and transmission of media content items and associated information to the electronic devices 102. For instance, a CDN 106 may cache media content items, playlists, and associated data and may be configured to transmit this data to electronic devices 102 through the network(s) 112 in response to requests from the electronic devices.

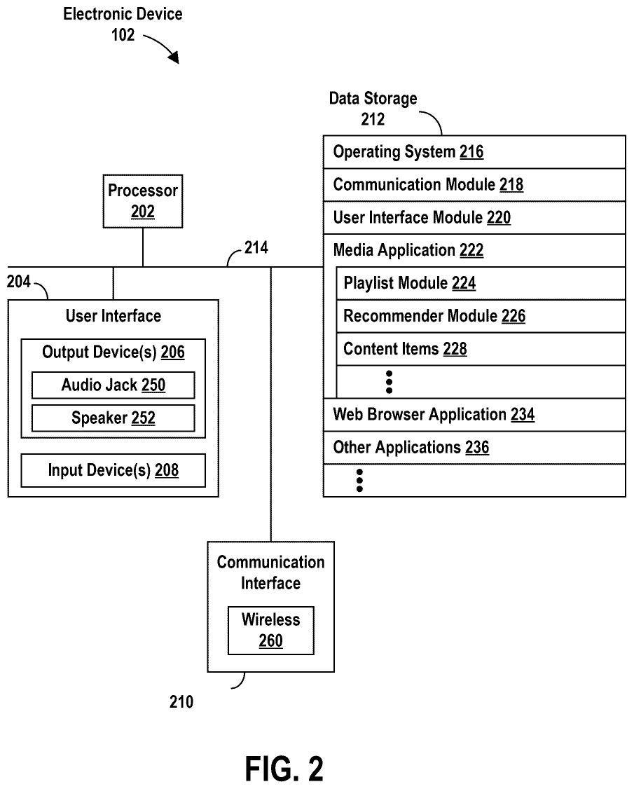

FIG. 2 is simplified a block diagram illustrating an example electronic device 102. As shown in FIG. 2, the example electronic device 102 includes a processor 202, a user interface 204, a communication interface 210, and non-transitory data storage 212, any or all of which may be integrated together to various extents and/or communicatively linked with each other by a system bus, network, or other connection mechanism 214, on a chipset or other integrated circuit, among other possibilities.

The processor 202 may include one or more general purpose processors (e.g., microprocessors) and/or one or more specialized processors (e.g., digital signal processors (DSPs), graphics processing units (GPUs), neural processing units (NPUs), etc.)

The user interface 204 may include one or more output devices 206 and one or more input devices 208 to facilitate interaction with a user. Example output devices 206 may include audio output devices such as an audio jack 250, a sound speaker 252, and/or another port or the like for connecting with speakers, earbuds, headphones, and/or other listening devices, and video output devices, such as a display panel for instance. Further, example input devices 208 may include an audio input device such as a microphone and other types of user input mechanisms such as a touch-sensitive panel, a keyboard or keypad, and/or a mouse or trackpad, among other possibilities. In some embodiments, the user interface may support voice input, and the electronic device 102 may include or interact with a voice recognition system to facilitate processing of voice input from a user.

The communication interface 210 may include one or more components to facilitate communicating with other electronic devices 102, with the media content server 104, with the CDN 106, with associated media presentation systems, and/or with other devices and/or systems. For instance, the communication interface 210 may include one or more wireless communication interfaces 260 configured to facilitate direct or networked communication according to any of various wireless communication protocols, such as those noted above, among others. In addition or alternatively, the communication interface 210 may include one or more wired communication interfaces supporting direct or networked communication according to any of various wired communication protocols, such as HDMI, Universal Serial Bus (USB), THUNDERBOLT, and/or Ethernet, among others.

The non-transitory data storage 212 may include one or more volatile and/or non-volatile storage components (e.g., flash, optical, magnetic, read only memory (ROM), random access memory (RAM) (e.g., dynamic RAM (DRAM), static RAM (SRAM), or double data rate RAM (DDRAM)), electronically programmable read only memory (EPROM), and/or electronically erasable programmable read only memory (EEPROM), etc.), which may be integrated in whole or in part with the processor 202 or may be provided separately. As further shown, the data storage 212 may store program instructions, which may be executable by the processor 202 to carry out various electronic device operations.

These instructions may define programs, modules, and/or data structures, such as but not limited to an operating system 216, a communication module 218, a user interface module 220, a media application 222, a web browser application 234, and one/or more other applications 236. Further, these instructions may be structured as separate software programs, procedures, modules, or the like, and/or may be combined together and/or otherwise arranged in various embodiments.

The operating system 216 may define procedures for handling various basic system services and for performing hardware-dependent tasks. The communication module 218 may define procedures supporting connection and communication with other computing devices and systems (e.g., with the media content server 104, the CDN 106, with various media presentation systems, and/or with other electronic devices 102) through the communication interface 210 and possibly the one or more networks 112. And the user interface module 220 may define procedures supporting use of the user interface 204, such as to receive commands and/or other input from a user and to provide media playback and other output to the user.

In line with the discussion above, the media application 222 may be a program application configured to access a media-providing service of a media-content provider associated with the media content server 104 for instance, and may be configured to support requesting, receiving, processing, and presenting of media content items. In some implementations, the media application 222 may include a media-player, a streaming-media application, and/or any other appropriate application or component to facilitate retrieval and/or receipt of media content and playing of the media content. Further, the media application 222 may be configured to monitor, store, and/or transmit (e.g., to the media content server 104) data associated with user behavior, with user permission. Further, the media application 222 may define various logic modules, such as a playlist module 224, a recommender module 226, and/or a content-items module 228.

The playlist module 224 may store sets of media items for playback in a predefined order. Further, the playlist module 224 may be configured to generate playlists. In some embodiments, the playlist module 224 may include a diffusion-model component, a large-language-model component, and/or a nearest-neighbor-search component, among other possibilities. The recommender module 226 may be configured to identify and/or display recommended media content items (e.g., for inclusion in a playlist). The recommender module 226 may likewise include a diffusion-model component, a large-language-model component, and/or a nearest-neighbor-search component, among other possibilities. The content-items module 228 may be configured to store media content items, including audio items such as songs, podcasts, and audiobooks, for playback, and to provide requests for media content items to the media content server 104. In some implementations, the content-items module 228 may include or otherwise have access to a set of vector representations for the media content items.

The web browser application 234 may be configured to support user access, viewing, and interaction with web sites. To facilitate this, the web browser application 234 may be configured to use standard web-based communication protocols, web-based applications, and/or web-based content formats and/or may be configured to use proprietary protocols, applications, and formats.

The other applications 236 in the non-transitory data storage 212 of the electronic device 102 may then include any of a variety of additional applications, supporting operations such as word processing, calendaring, mapping, weather, time keeping, virtual digital assistant, presenting, drawing, instant messaging, e-mail, telephony, video conferencing, photo management, video management, music playing, video playing, 2D gaming, 3D (e.g., virtual reality) gaming, electronic book reading, and/or workout management, among other possibilities.

The example electronic device 102 may also include one or more sensors (not shown) such as accelerometers, gyroscopes, compasses, magnetometer, light sensors, near field communication transceivers, barometers, humidity sensors, temperature sensors, proximity sensors, range finders, and/or other devices for sensing and measuring various operational, environmental and/or other conditions, among possibly other components.

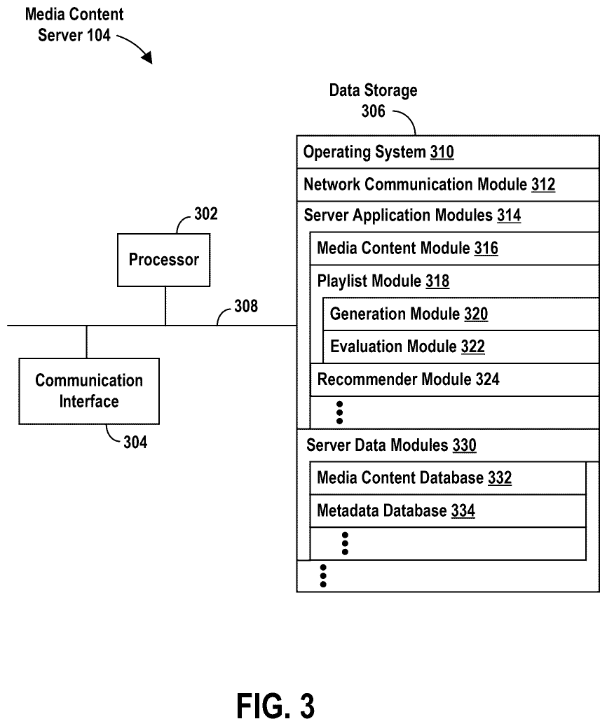

FIG. 3 is next a simplified block diagram of an example media content server 104. As shown in FIG. 3, the example media content server 104 includes a processor 302, a communication interface 304, and non-transitory data storage 306, any or all of which may be integrated together to various extents and/or communicatively linked with each other by a system bus, network, or other connection mechanism 308, on a chipset or other integrated circuit, among other possibilities.

The processor 302 may include one or more general purpose processors (e.g., microprocessors) and/or one or more specialized processors (e.g., DSPs, GPUs, NPUs, etc.)

The communication interface 304 may comprise a network communication interface to facilitate communicating with the electronic devices 102 and the CDN 106 through the one or more networks 112. For instance, the communication interface 304 may include a wired and/or wireless Ethernet communication module, among other possibilities.

The non-transitory data storage 306 may include one or more volatile and/or non-volatile storage components (e.g., flash, optical, magnetic, ROM, RAM) (e.g., DRAM, SRAM, or DDRAM), EPROM, and/or EEPROM, etc.), which may be integrated in whole or in part with the processor 302 or may be provided separately. As further shown, the data storage 306 may store program instructions, which may be executable by the processor 302 to carry out various media-content-server operations.

These instructions may define programs, modules, and/or data structures, such as but not limited to an operating system 310, a network communication module 312, one or more server application modules 314, and one or more server data modules 330. Further, these instructions may be structured as separate software programs, procedures, modules, or the like, and/or may be combined together and/or otherwise arranged in various embodiments.

The operating system 310 may define procedures for handling various basic system services and for performing hardware-dependent tasks. And the communication module 312 may define procedures supporting connection and communication with other computing devices and systems, such as with the electronic devices 102 and the CDN 106, through the communication interface 304 and possibly through the one or more networks 112.

The one or more server application modules 314 may define procedures supporting providing and managing a content service. These server application modules 314 may include a media content module 316, a playlist module 318, and/or a recommender module 324, among other possibilities.

The media content module 316 may store and/or otherwise have access to media content items and may be configured to send (e.g., stream and/or progressively transmit) the media content items to the electronic devices 102. The playlist module 318 may store and/or otherwise have access to data defining sequences or other sets of media content items and may be configured to send those playlists to the electronic devices 102. The playlist module 318 may include a generation module 320 for generating playlists and media sets, and an evaluation module 322 for evaluating the playlists and media sets, e.g., before and after publication. Further, the playlist module 318 may include a diffusion-model component, a large-language-model component, and/or a nearest-neighbor-search component, among other possibilities.

The recommender module 324 may determine and/or provide media-content-item recommendations (e.g., for a playlist). In some embodiments, the recommender module 324 also includes a diffusion-model component, a large-language-model component, and/or a nearest neighbor-search component, among other possibilities.

The one or more server data modules 330 may manage the storage of and/or access to media items and/or metadata relating to media content items. As such, the one or more server data modules 330 may include a media content database 332 for storing media items and/or vector representations (e.g., vector embeddings) of the media content items, and a metadata database 334 for storing metadata relating to the media content items, such as genre, artist, and other information associated with the respective media content items.

The media content server 104 may also include a web server such as a Hypertext Transfer Protocol (HTTP) servers, File Transfer Protocol (FTP) servers, and may maintain or otherwise have access to web pages and other content defined with Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), XHP, Javelin, Wireless Universal Resource File (WURFL), and the like.

The description of the media content server 104 as a “server” is intended as a functional description of the devices, systems, processor cores, and/or other components that provide the functionality attributed to the media content server 104. It will be understood that the media content server 104 may be a single server computer, or may comprise multiple server computers. Moreover, the media content server 104 may be coupled with CDN 106 and/or other servers and/or server systems, or other devices, such as other client devices, databases, content delivery networks (e.g., peer-to-peer networks), network caches, and the like. Further, in some embodiments, the media content server 104 may be implemented by multiple computing devices working together to perform the actions of a server system, such as to provide cloud-based server or cloud-computing service.

### II. Digital Audio Content and Streaming

Digital audio content may encompass a broad range of audio data that has been converted into a digital format, enabling it to be stored, processed, transmitted, and received by electronic devices. By way of example, digital audio content could include songs and other music, as well as spoken word recordings such as news broadcasts, podcasts, audiobooks, that offer listeners a convenient way to consume information and entertainment through auditory means. Further, digital audio content could combine spoken word with music or other sounds, creating rich, multi-layered audio experiences suitable for radio shows, multimedia presentations, and enhanced podcasts. And still further, digital audio content could constitute the audio portion of multimedia video content (e.g., of H.264/MPEG-4 or 3GP encoded content), such as the soundtrack of a movie, television show, online video, or live stream, among many other possibilities.

Digital audio content represents analog audio content as a sequence of digital information such as a bits representing sequential frames of the analog audio. Digital audio content may be compressed or otherwise encoded using various encoding techniques (e.g., MP3, AAC, or Opus) to help reduce file size while maintaining quality and to help facilitate distribution of the audio through various techniques such as streaming, progressive downloading, bulk file transfer, or broadcasting, for instance.

Digital audio streaming involves transmitting a digital audio stream from a content source (e.g. media content server 104 or CDN 106) to an electronic device 102, typically over a network 112, for real-time playout of the audio by the electronic device 102 as the electronic device 102 receives the transmission. A variation of audio streaming is progressive downloading, where an electronic device 102 downloads a digital audio file in pieces and plays out the audio file before the entire download is finished. One technical difference between streaming and progressive downloading is that, with streaming, the electronic device 102 usually does not maintain a copy of the audio as the electronic device 102 plays it out, whereas with progressive downloading, the electronic device 102 ends up with a downloaded copy of the audio for possible later playout as well.

To prepare digital audio for streaming or other distribution, a computing system such as the media content server 104 may start with a digital audio file that defines a time sequence of digital audio data such as a sequence of audio frames, the computing system may encode the digital audio data of the file using an encoding algorithm to establish a corresponding time sequence of encoded digital audio data, and the computing system may segment the encoded digital audio data into smaller pieces or audio segments, which the computing system may store for transmission. Further, the computing system may generate multiple different encoded versions of the digital audio segments per file, using multiple different levels or types of encoding and compression, to facilitate adaptive switching between versions during transmission.

To facilitate streaming of an audio content item to an electronic device 102, the media content server 104 may employ a streaming protocol such as HTTP Live Streaming (HLS), Dynamic Adaptive Streaming over HTTP (DASH), or Real-Time Messaging Protocol (RTMP) to transmit the audio segments. These protocols manage the data transmission and adapt to varying network conditions. Additionally, the media content server 104 may handle user sessions, managing requests for specific audio streams and providing secure access through authentication and authorization mechanisms. The media content server 104 may also make use of the CDN 106, which may cache the audio content pieces on geographically distributed servers, to help reduce streaming latency and improve reliability and user experience.

On the receiving end, the media application 222 of the electronic device 102 may initiate a connection to the media content server 104 and request streaming of a specific audio content item. As the media application 222 receives the initial audio segments of the requested audio content in response to this request, the media application 222 may then start buffering and pre-loading a portion of the audio in the memory of the electronic device 102 to facilitate smooth playback even in the case of minor network interruptions. Further, the media application 222 may decode the audio pieces in order to uncover the original digital audio data and may convert that digital audio data to a form suitable for output. For instance, the media application 222 may play the decoded audio through an audio output device 206 of the electronic device 102 or through another electronic device 102. Further, the media application 222 may manage playback (e.g., play, pause, skip, and volume adjustment) through associated user-interface controls.

Adaptive streaming protocols such as those discussed above may allow the electronic device 102 to monitor network conditions and request different quality levels of digital audio content based on current bandwidth availability, thus providing consistent playback without interruptions in most cases. Further, the electronic device 102 may handle network errors and interruptions by attempting to reconnect to the media content server 104, by re-buffering when necessary, and by dynamically adjusting the stream quality to maintain a continuous audio experience.

### III. Machine Learning Models

Various types of machine learning models can be used to select media content items for streaming to electronic devices 102. These machine learning models may be part of, operate in conjunction with, and/or be accessed by media content server 104. Two example machine learning models are described below, but others may be employed.

Gradient boosted decision trees (GBDTs) are supervised machine learning models that operate by iteratively combining the predictive power of a number of individual decision trees to produce an ensemble predictor. Specifically, GBDTs iteratively build decision trees in sequential fashion, with each subsequent tree aiming to correct errors (residuals) made by the previously constructed trees. Each iteration applies a gradient descent procedure seeking to reduce the value produced by a predefined loss function. As each tree is constructed, residuals calculated from predictions of previous iterations serve as target values, thus guiding the growth and parameterization of subsequent trees. This additive and corrective process continues until a predetermined stopping criterion-such as model complexity, minimal gain, or a validation-based convergence criterion-is met.

In practical terms, a GBDT model typically comprises numerous shallow decision trees, each providing incremental improvements to the overall prediction accuracy. Each individual tree within the ensemble contributes a weighted adjustment toward the final prediction, whereby tree parameters, such as node-splits and leaf-weights, are derived from the gradient-based optimization of the specified objective function. This approach allows GBDTs to capture complex, nonlinear interactions in data, often achieving superior predictive performance and interpretability compared to single-tree methods. Commonly employed loss functions include mean squared error (for regression-based uses) and cross-entropy (for classification-based uses). Implementations can utilize stochastic or mini-batch sampling techniques to improve computational efficiency.

Neural network models, in contrast, represent computational structures inspired by biological neural networks, composed of interconnected processing units referred to as neurons or nodes, organized into layers including input, hidden, and output layers. Each neuron aggregates weighted inputs through a linear combination, subsequently passing the summed value through a nonlinear activation function, such as sigmoid, rectified linear unit (ReLU), hyperbolic tangent (tanh), or softmax. The interconnection weights between neurons and layer biases are iteratively adjusted during a training process, commonly based on gradient descent or its variations (e.g., stochastic gradient descent or adaptive moment estimation), to reduce discrepancies between model predictions and known outcomes.

The structure of neural network models can range from simple feed-forward designs, in which data flows unidirectionally from input to output layers, to more complex architectures including recurrent neural networks (RNNs), convolutional neural networks (CNNs), and transformers, each tailored to specific tasks such as time-series analysis, image processing, or language modeling, respectively. Neural networks possess significant representational capacity, enabling the approximation of highly nonlinear functions and detection of complex patterns from extensive and high-dimensional datasets.

### IV. Improved Media Recommendation Systems

In the following, for sake of simplicity, only two media content types are considered—music and talk content (e.g., podcasts and/or audiobooks). However, the techniques set forth herein could be readily generalized to three or more media content types (e.g., music, podcasts, videos, and/or audiobooks). This does not imply that podcasts or audiobooks cannot be accompanied by music from time to time (e.g., background music to set a mood or musical interludes between chapters or sections), just that the talk aspect of their content is prominent. Likewise, this does not imply that music tracks cannot have spoken word content.

In some cases, media content items may be arranged for display to a user on virtual “shelves” based on their media content types. Each virtual shelf may be a row of media content items of the same type, and different virtual shelves may display media content items of different types. For example, if there is room on the user interface for five virtual shelves, four may be dedicated to music and one may be dedicated to talk content.

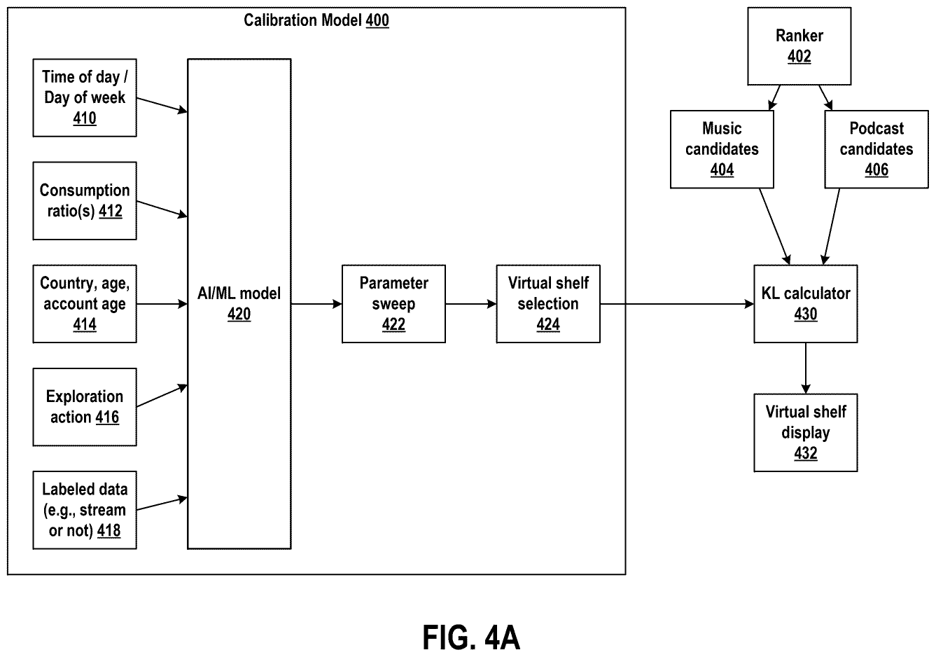

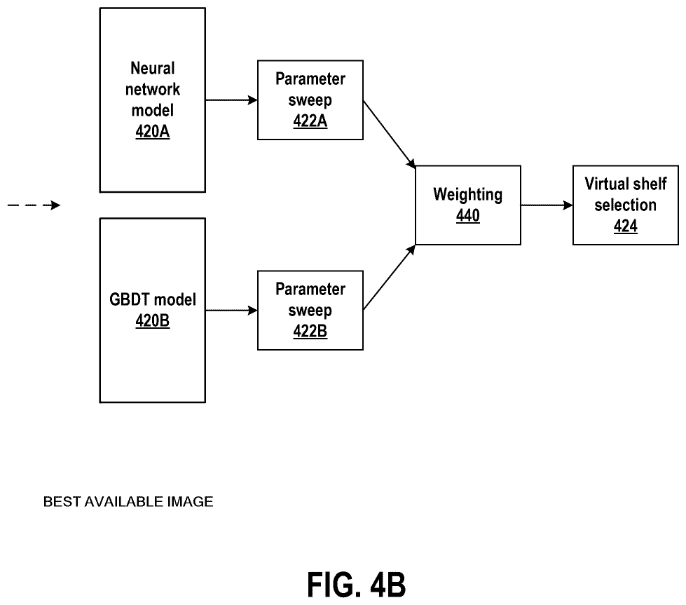

FIG. 4 depicts an example media content recommendation system. It is assumed that an ordered list of music candidates 404 and an ordered list of talk content candidates 406 (e.g., podcasts) are available. These lists may be each ranked, by ranker 402, in descending order of relevance to the user (e.g., the media content item deemed most relevant to the user is at the top of the list, the media content item deemed second-most relevant to the user is second from the top of the list, and so on). Ranker 402 may be a software module that operates a ranker algorithm. Here, the relevance for each media content item may be the probability-as determined by the ranker algorithm—that the user will consume the media content item.

Ranker algorithms for media content recommendation may attempt to sort media content items based on predicted relevance, user preferences, and/or contextual factors. Several approaches exist. Collaborative filtering ranker algorithms make recommendations based on user-item interaction matrices by identifying similar users or items through methods like matrix factorization or neighborhood-based filtering. For example, these techniques may model user-item interactions as latent feature spaces, ranking items according to predicted interaction scores. Content-based rankers utilize item-specific metadata, textual descriptions, audio features, and/or categorical tags, employing machine learning classifiers or vector embedding techniques, such as Word2Vec, Doc2Vec, or transformer-based embeddings (BERT), to recommend items based on their similarity to content previously consumed by the user. Other possibilities exist.

### A. Model Inference

In FIG. 4, calibration model 400 may be employed. This model may take as input the time and day of the week 410, the user's consumption ratio(s) 412 (e.g., 70% music, 30% talk content) over the last 7 and/or 90 days, the user's country, age, and account age 414, an exploration action 416 (e.g., for Gaussian exploration discussed below), labeled data 418 (e.g., whether or not a given media content item was streamed by the user), and so on. Calibration model 400 may use a trained artificial intelligence/machine learning (AI/ML) model 420 to make predictions. Example models include GBDT and neural network models, but other models may be used additionally or instead.

The output of AI/ML model 420 includes a likelihood that the user will select at least one media content item from a particular arrangement of virtual shelves (optionally referred to as “a virtual shelf composition”) displayed to the user. In other words, given the input parameters to the AI/ML model 420 (e.g., time and day of the week, the user's consumption ratio, the user's country, age, and account age, etc.) and a set percentage of virtual shelf space dedicated to each media content type, AI/ML model 420 predicts the likelihood that the user will select (e.g., for partial or full consumption) at least one media content item across these shelves. Importantly, the media content items themselves do not have to be considered at this point-the prediction can be made based on the virtual shelf arrangement.

A parameter sweep 422 may be performed over a plurality of virtual shelf arrangements. For instance, 21 different virtual shelf arrangements with content types changing in increments of 5% could be considered (e.g., 0% music, 100% talk content; 5% music, 95% talk content, . . . , 95% music, 5% talk content, 100% music, 0% talk content). Of these, the virtual shelf arrangement with the highest likelihood of at least one engagement with at least one media content item may be selected (e.g., 75% music, 25% talk content) as virtual shelf selection 424. Parameter sweep 422 be executed in parallel through vectorized GPU operations.

Here, an engagement may be one or more of the user playing out a media content item (e.g., streaming some, at least a specific portion of, or all of the media content item), downloading a media content item, adding a media content item to a playlist, sharing a link to a media content item (e.g., via social media), and/or reacting to a media content item with emojis or other types of responses. Other possibilities exist.

Next, virtual shelf selection 424 is populated from the ranked media content items. These media content items are selected from their respective rankings according to type. The selections may be made greedily. For example, the music virtual shelves of virtual shelf selection 424 can be populated starting with the music content item with the highest ranking from music candidates 404, and working down through the rankings from there. Likewise, the podcast virtual shelves of virtual shelf selection 424 can be populated starting with the podcast content item with the highest ranking from podcast candidates 406, and working down through the rankings from there. This may be done while using KL calculator 430 to minimize the Kullback-Leibler (KL) divergence from a target distribution of media content items per media content type. The result is virtual shelf display 432, which is virtual shelf selection 424 populated with content from music candidates 404 and podcast candidates 406.

Also, different time horizons can be taken into account by filtering the training data. For instance, a time horizon of 90 days may be a reasonable representation of a user's long-term consumption patterns, while a time horizon of 7 days might reflect short-term patterns (e.g., even a music-heavy user might listen to more podcasts about sporting events before and after the NFL Superbowl than during the rest of the year). Whatever calculations are performed for a 90-day time horizon can also be performed for a 7-day time horizon. A neural network based model, as just one possible example, can combine the long-term (90 day) and short term (7 day) patterns to provide a virtual shelf arrangement that takes both into account.

FIG. 4B depicts a variation of calibration model 400 that uses an ensemble of machine learning models in place of AI/ML model 420. Particularly, neural network model 420A and GBDT model 420B may each be independently applied to the input data (e.g., time and day of the week 410, consumption ratio(s) 412, country, age, and account age 414, exploration action 416, labeled data 418, and so on). Further, independent parameter sweeps 422A and 422B may be performed for each for these models, respectively. Weighting 440 may be applied to the results of the parameter sweeps. For example, a weight 0.0≤w≤1.0 may be used such that the formula

s=wNN+(1−w)GBDT

is used to obtain virtual shelf selection 424, where NN is the output of parameter sweep 422A and GBDT is the output of parameter sweep 422B.

Nonetheless, other types of ensembles with different models and/or a different number of models may be used. Thus, the virtual shelf selection can be obtained in various ways.

### B. Model Training

AI/ML model 420 may be trained on the user's historical consumption data given the arrangements of virtual shelves provided to the user. Notably, the user's historical consumption data can be collected in real time or over the course of a period of time (e.g., per day). Thus, the content recommendations generated by way of AI/ML model 420 during inference can be tuned to explore the user's reaction to content to which the user might not otherwise be exposed.

For example, the “long tail” nature of content popularity refers to a distribution pattern where a relatively small number of popular items account for a significant portion of consumption, while a large number of niche or less popular items individually have relatively little consumption but collectively represent a substantial share of total consumption. In the context of music, a few popular songs from a catalog of 100 million each may be consumed tens of millions of times per year, while songs from less-known or independent artists (which make up most of the catalog) might only be consumed a few hundred or thousand times per year.

To offset the “long tail” phenomenon, increase the diversity of media content items suggested to users, and facilitate suggestion of different media content types to user (e.g., so that a user who only listens to music can be recommended talk content), a small percentage (e.g., 1.5%) of all requests may be served by an algorithm that provides a version of the suggestions with randomized content. While these content suggestions could be truly randomized, another approach is to use Gaussian exploration. To that end, for a user with a 90-day music/talk content split of 0.7/0.3, a Gaussian distribution may be built around the 0.7 term based on user consumption history. Then three standard deviations, e.g., normalized to 0.3, 0.5, and 0.7, may be determined (one or more of these standard deviations may be part of exploration action 416). The process then samples the Gaussian distribution from these three standard deviations. When AI/ML model 420 is trained, this data is multiplied by the inverse propensity weight (IPW) so that the tails of the Gaussian distribution are emphasized.

This allows collection of richer training data, namely the user consumption data for less popular media content items that are each individually not likely to be suggested. The user consumption data may be based on whether the user ignores, selects, begins consumption, and/or completes consumption of the suggested media content items. But when the user consumes the randomized content, such content might be up-weighted (e.g., by 10-100 times) in order to “nudge” the suggestions made to the user. In certain cases, some specific media content types (e.g., podcasts) may be up-weighted (e.g., by 1.5 times) for the same reason.

In this fashion, the inference behavior of AI/ML model 420 can be adjusted so that the training data can be expanded to parts of the catalog and media content types for which user consumption data might otherwise be unavailable. AI/ML model 420 can be retrained periodically or from time to time (e.g., once per day, once per week) based on the training data as updated. Thus, the media content item suggestions provided by AI/ML model 420 can be used as training input to further iterations of AI/ML model 420.

As an example, one unit of training data may be obtained by displaying 6 virtual shelves containing music recommendations and 4 virtual shelves containing talk content recommendations. If the user does not consume any media content item on any of these shelves, the output is a 0. If the user does consume at least one media content item on these shelves, the output is a 1. Repeating this process a number of times (e.g., 30, 50, 100, or more) results in a probability that the user will engage one or more media content items displayed on this arrangement of virtual shelves (e.g., 57%).

This output can be personalized per user, e.g., based on user demographics, time of day, user device, etc. For instance, if a user has a proclivity to listen to podcasts in the early morning while exercising and music in the evening while relaxing, AI/ML model 420 can take that into account.

### C. Overview of Features

Below is a listing of features that may be used in either the training or inference stages. This is not an exhaustive list of features used by the embodiments herein.

Collecting per-user interactions with a media recommendation system as training data, including (i) input of counts of virtual shelves for different media content types, user-specific information, time of day, day of week, and device type, and (ii) output of whether the user engaged with the any of the media content items suggested by the media recommendation system.

Training a machine learning (e.g., neural network) model based on these per-user interactions to predict whether the user will interact with at least one media content item provided by a specific split of media content types between virtual shelves.

Where, during inference, a plurality of virtual shelf arrangements for various mixes of media content types are provided, and the virtual shelf arrangement with the highest likelihood of user engagement is selected (e.g., user engagement with at least one media content item).

Where a small portion (e.g., 1.5%) of all requests for recommendations are supplied by a randomized model.

Where the randomized model uses Gaussian exploration to vary the split of media content types within a predefined standard deviation.

Where user selections of low-propensity media content items or specific media content types are up-weighted for purposes of future recommendation.

In the features above, the user's consumption history over a long term (e.g., 90 days) and a short term (e.g., 7 days) are both considered.

The selected virtual shelf arrangement is populated with ranked media content items matching the types of the virtual shelves.

Where, based on timing patterns of the user's consumption history, the model can produce different suggestions for the same user at different times of day.

### V. Example Technical Improvements

These embodiments provide a technical solution to a technical problem. One technical problem being solved is making efficient and accurate recommendations of media content items (e.g., music, podcasts, videos, and/or audiobooks) to users. In practice, this is problematic because inefficient and/or inaccurate recommendation systems lead to excessive computation resource consumption (e.g., processing, memory, network, and/or power capacity).

Current recommendation systems might overemphasize a user's primary type of media content item that they consume. For example, historical data for a user may indicate that the user spends 95% of their consumption time listening to music, with the remaining 5% of this time split between podcasts and audiobooks. A naïve media recommendation system may determine from this historical data-that the user is likely to prefer almost any music content item over almost any podcast or audio book. Thus, the system could recommend music 100% of the time and no podcasts or audiobooks, effectively underrepresenting talk content in the recommendations. Using the embodiments herein, the system may actually provide better recommendations by over-emphasizing the user's less popular media content types.

Improving a media content item recommendation system can directly lead to technical enhancements in computing systems by reducing resource consumption such as processing, memory, network, and/or power capacity. A more accurate recommendation algorithm reduces unnecessary processing by precisely identifying relevant media content items to recommend, eliminating extensive computations associated with analyzing large datasets of user behavior or content metadata. Consequently, less processor time and fewer memory resources are spent on redundant analyses. Moreover, when users receive accurate recommendations, they spend less time browsing, sampling, or initiating unnecessary playout of media content items, significantly decreasing network traffic and bandwidth consumption. Fewer requests and shorter streaming sessions directly translate into reduced power usage across servers, data centers, and user devices. Thus, enhanced recommendation accuracy leads to a more efficient, sustainable, and resource-friendly computing infrastructure.

Further, the embodiments herein provide for an efficient and accurate assembly of a customized home page or other user interface for media content items. The customizations can include recommendations and/or representations of media content items of multiple different content types. For example, selection of a virtual shelf composition that has a high likelihood of user engagement for a respective distribution of content allows the user to focus on media content items that are likely to be most relevant to the user. This reduces the chance that the user invokes the computational cost of further searches.

Other technical improvements may also flow from these embodiments, and other technical problems may be solved. Thus, this statement of technical improvements is not limiting and instead constitutes examples of advantages that can be realized from the embodiments.

### VI. Example Operations

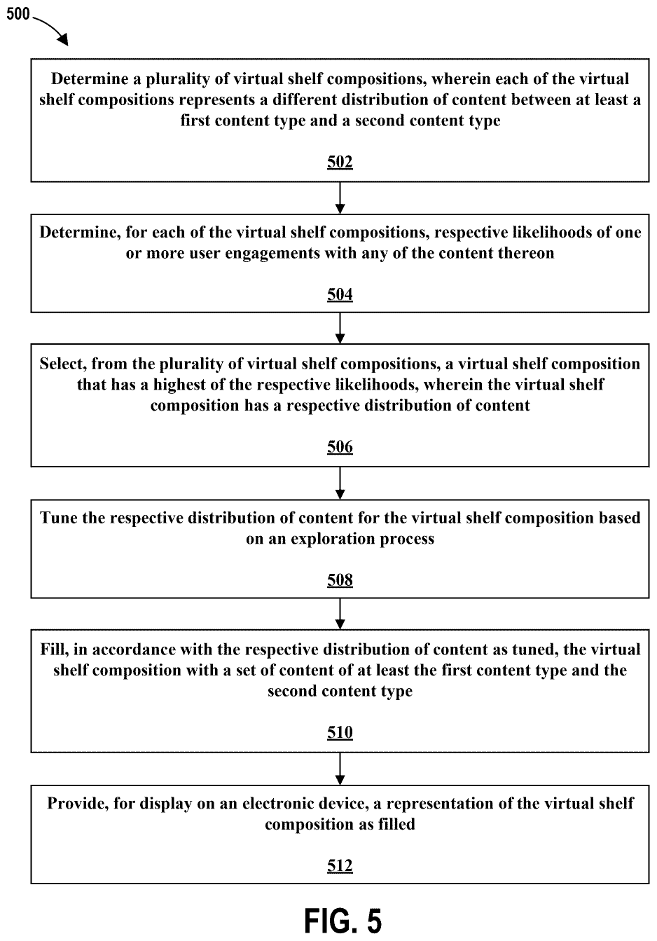

FIG. 5 is a flow chart 500 illustrating an example embodiment. The process illustrated by FIG. 5 may be carried out by a computing device, such as media content server 104, and/or one or more additional computing devices arranged to prepare digital audio content. Alternatively, the process can be carried out by other types of devices or device subsystems.

The embodiments of FIG. 5 may be simplified by the removal of any one or more of the features shown therein. Further, these embodiments may be combined with features, aspects, and/or implementations of any of the previous figures or otherwise described herein.

Block 502 may involve determining a plurality of virtual shelf compositions, wherein each of the virtual shelf compositions represents a different distribution of content between at least a first content type and a second content type.

Block 504 may involve determining, for each of the virtual shelf compositions, respective likelihoods of one or more user engagements with any of the content thereon.

Block 506 may involve selecting, from the plurality of virtual shelf compositions, a virtual shelf composition that has a highest of the respective likelihoods, wherein the virtual shelf composition has a respective distribution of content.

Block 508 may involve tuning the respective distribution of content for the virtual shelf composition based on an exploration process.

Block 510 may involve filling, in accordance with the respective distribution of content as tuned, the virtual shelf composition with a set of content of at least the first content type and the second content type.

Block 512 may involve providing, for display on an electronic device, a representation of the virtual shelf composition as filled.

In some embodiments, the plurality of virtual shelf compositions comprise candidate virtual shelf compositions for a particular user.

In some embodiments, the plurality of virtual shelf compositions are based on one or more of, for a particular user: a time of day, a day of week, a content consumption history (e.g., of 3-10 days or 30-120 days), a country, an age, or an account age.

In some embodiments, the first content type is one of music, podcasts, videos, or audiobooks, wherein the second content type is one of music, podcasts, videos, or audiobooks, wherein the first content type is different from the second content type.

In some embodiments, the respective distribution of content for the virtual shelf composition is tuned before the virtual shelf composition is selected.

In some embodiments, the respective likelihoods of the one or more user engagements are based on the virtual shelf composition regardless of any particular content therein.

In some embodiments, the one or more user engagements are one or more of: playing out a media content item, downloading the media content item, adding the media content item to a playlist, sharing a link to the media content item, or reacting to the media content item.

In some embodiments, the virtual shelf composition includes one or more virtual shelves in which the set of content is placed.

In some embodiments, the exploration process is a Gaussian exploration process.

In some embodiments, the respective distribution of the content includes more of the first content type than the second content type, wherein tuning the respective distribution of the virtual shelf composition comprises increasing an amount of the second content type.

In some embodiments, filling the virtual shelf composition with the set of content comprises populating virtual shelves of the virtual shelf composition with media content items of the first content type and the second content type.

In some embodiments, each of the virtual shelves contains the media content items only of a particular content type.

In some embodiments, each of the virtual shelves contains the media content items from a pre-established ranking of the media content items.

In some embodiments, providing the representation of the virtual shelf composition as filled comprises transmitting, to the electronic device, the representation of the virtual shelf composition as filled, wherein reception of the representation of the virtual shelf composition as filled by the electronic device causes the electronic device to display the representation of the virtual shelf composition as filled.

Some embodiments may further involve: receiving, from the electronic device, an indication of detected user engagement with a particular media content item, wherein the particular media content item was present in the representation of the virtual shelf composition as filled; and based on the indication of the detected user engagement, updating the respective likelihoods.

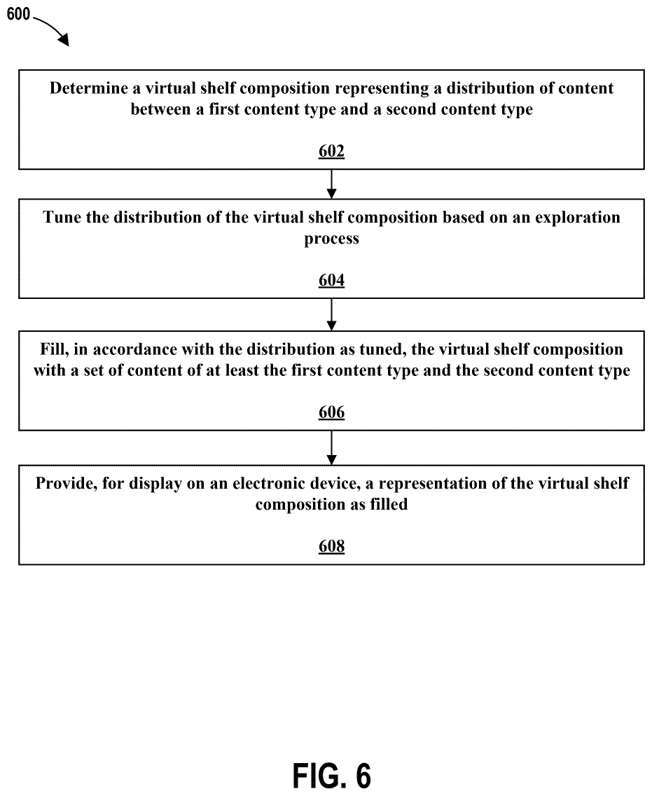

FIG. 6 is a flow chart 600 illustrating an example embodiment. The process illustrated by FIG. 6 may be carried out by a computing device, such as media content server 104, and/or one or more additional computing devices arranged to prepare digital audio content. Alternatively, the process can be carried out by other types of devices or device subsystems.

The embodiments of FIG. 6 may be simplified by the removal of any one or more of the features shown therein. Further, these embodiments may be combined with features, aspects, and/or implementations of any of the previous figures or otherwise described herein.

Block 602 may involve determining a virtual shelf composition representing a distribution of content between a first content type and a second content type.

Block 604 may involve tuning the distribution of the virtual shelf composition based on an exploration process.

Block 606 may involve filling, in accordance with the distribution as tuned, the virtual shelf composition with a set of content of at least the first content type and the second content type.

Block 608 may involve providing, for display on an electronic device, a representation of the virtual shelf composition as filled.

In some embodiments, the virtual shelf composition is for a particular user.

In some embodiments, the virtual shelf composition is based on one or more of, for a particular user: a time of day, a day of week, a content consumption history (e.g., of 3-10 days or 30-120 days), a country, an age, or an account age.

In some embodiments, the first content type is one of music, podcasts, videos, or audiobooks, wherein the second content type is one of music, podcasts, videos, or audiobooks, wherein the first content type is different from the second content type.

In some embodiments, the distribution of content for the virtual shelf composition is tuned before the virtual shelf composition is determined.

In some embodiments, the virtual shelf composition includes one or more virtual shelves in which the set of content is placed.

In some embodiments, the exploration process is a Gaussian exploration process.

In some embodiments, the distribution of the content includes more of the first content type than the second content type, wherein tuning the distribution of the virtual shelf composition comprises increasing an amount of the second content type.

In some embodiments, filling the virtual shelf composition with the set of content comprises populating virtual shelves of the virtual shelf composition with media content items of the first content type and the second content type.

In some embodiments, each of the virtual shelves contains the media content items only of a particular content type.

In some embodiments, each of the virtual shelves contains the media content items from a pre-established ranking of the media content items.

In some embodiments, providing the representation of the virtual shelf composition as filled comprises transmitting, to the electronic device, the representation of the virtual shelf composition as filled, wherein reception of the representation of the virtual shelf composition as filled by the electronic device causes the electronic device to display the representation of the virtual shelf composition as filled.

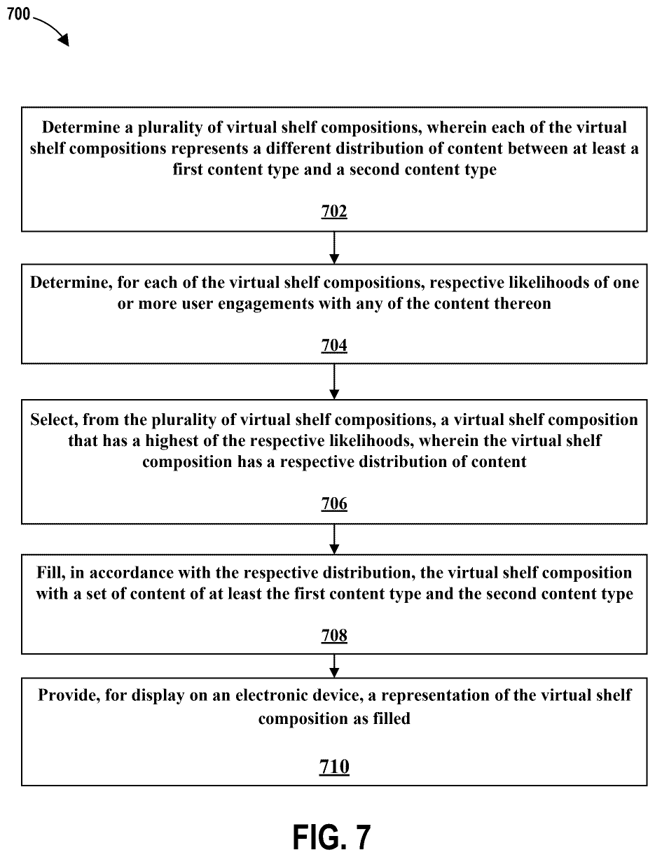

FIG. 7 is a flow chart 700 illustrating an example embodiment. The process illustrated by FIG. 7 may be carried out by a computing device, such as media content server 104, and/or one or more additional computing devices arranged to prepare digital audio content. Alternatively, the process can be carried out by other types of devices or device subsystems.

The embodiments of FIG. 7 may be simplified by the removal of any one or more of the features shown therein. Further, these embodiments may be combined with features, aspects, and/or implementations of any of the previous figures or otherwise described herein.

Block 702 may involve determining a plurality of virtual shelf compositions, wherein each of the virtual shelf compositions represents a different distribution of content between at least a first content type and a second content type.

Block 704 may involve determining, for each of the virtual shelf compositions, respective likelihoods of one or more user engagements with any of the content thereon.

Block 706 may involve selecting, from the plurality of virtual shelf compositions, a virtual shelf composition that has a highest of the respective likelihoods, wherein the virtual shelf composition has a respective distribution of content.

Block 708 may involve filling, in accordance with the respective distribution, the virtual shelf composition with a set of content of at least the first content type and the second content type.

Block 710 may involve providing, for display on an electronic device, a representation of the virtual shelf composition as filled.

In some embodiments, wherein the plurality of virtual shelf compositions comprise candidate virtual shelf compositions for a particular user.

In some embodiments, the plurality of virtual shelf compositions are based on one or more of, for a particular user: a time of day, a day of week, a content consumption history (e.g., of 3-10 days or 30-120 days), a country, an age, or an account age.

In some embodiments, the first content type is one of music, podcasts, videos, or audiobooks, wherein the second content type is one of music, podcasts, videos, or audiobooks, wherein the first content type is different from the second content type.

In some embodiments, the respective likelihoods of the one or more user engagements are based on the virtual shelf composition regardless of any particular content therein.

In some embodiments, the one or more user engagements are one or more of: playing out a media content item, downloading the media content item, adding the media content item to a playlist, sharing a link to the media content item, or reacting to the media content item.

In some embodiments, the virtual shelf composition includes one or more virtual shelves in which the set of content is placed.

In some embodiments, the respective distribution of the content includes more of the first content type than the second content type.

In some embodiments, filling the virtual shelf composition with the set of content comprises populating virtual shelves of the virtual shelf composition with media content items of the first content type and the second content type.

In some embodiments, each of the virtual shelves contains the media content items only of a particular content type.

In some embodiments, each of the virtual shelves contains the media content items from a pre-established ranking of the media content items.

In some embodiments, providing the representation of the virtual shelf composition as filled comprises transmitting, to the electronic device, the representation of the virtual shelf composition as filled, wherein reception of the representation of the virtual shelf composition as filled by the electronic device causes the electronic device to display the representation of the virtual shelf composition as filled.

Some embodiments further involve: receiving, from the electronic device, an indication of detected user engagement with a particular media content item, wherein the particular media content item was present in the representation of the virtual shelf composition as filled; and based on the indication of the detected user engagement, updating the respective likelihoods.

### VII. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of non-transitory computer readable medium such as a storage device including RAM, ROM, a disk drive, a solid-state drive, or another tangible storage medium.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A computer-implemented method comprising:
determining a plurality of virtual shelf compositions, wherein each of the virtual shelf compositions represents a different distribution of content between at least a first content type and a second content type;
determining, for each of the virtual shelf compositions, respective likelihoods of one or more user engagements with any of the content thereon;
selecting, from the plurality of virtual shelf compositions, a virtual shelf composition that has a highest of the respective likelihoods, wherein the virtual shelf composition has a respective distribution of content;
tuning the respective distribution of content for the virtual shelf composition based on an exploration process;
filling, in accordance with the respective distribution of content as tuned, the virtual shelf composition with a set of content of at least the first content type and the second content type; and
providing, for display on an electronic device, a representation of the virtual shelf composition as filled.

2. The computer-implemented method of claim 1, wherein the plurality of virtual shelf compositions comprise candidate virtual shelf compositions for a particular user.

3. The computer-implemented method of claim 1, wherein the plurality of virtual shelf compositions are based on one or more of, for a particular user: a time of day, a day of week, a content consumption history, a country, an age, or an account age.

4. The computer-implemented method of claim 1, wherein the first content type is one of music, podcasts, videos, or audiobooks, and wherein the second content type is one of music, podcasts, videos, or audiobooks, and wherein the first content type is different from the second content type.

5. The computer-implemented method of claim 1, wherein the respective distribution of content for the virtual shelf composition is tuned before the virtual shelf composition is selected.

6. The computer-implemented method of claim 1, wherein the respective likelihoods of the one or more user engagements are based on the virtual shelf composition regardless of any particular content therein.

7. The computer-implemented method of claim 1, wherein the one or more user engagements are one or more of: playing out a media content item, downloading the media content item, adding the media content item to a playlist, sharing a link to the media content item, or reacting to the media content item.

8. The computer-implemented method of claim 1, wherein the virtual shelf composition includes one or more virtual shelves in which the set of content is placed.

9. The computer-implemented method of claim 1, wherein the exploration process is a Gaussian exploration process.

10. The computer-implemented method of claim 1, wherein the respective distribution of the content includes more of the first content type than the second content type, and wherein tuning the respective distribution of the virtual shelf composition comprises increasing an amount of the second content type.

11. The computer-implemented method of claim 1, wherein filling the virtual shelf composition with the set of content comprises populating virtual shelves of the virtual shelf composition with media content items of the first content type and the second content type.

12. The computer-implemented method of claim 11, wherein each of the virtual shelves contains the media content items only of a particular content type.

13. The computer-implemented method of claim 11, wherein each of the virtual shelves contains the media content items from a pre-established ranking of the media content items.

14. The computer-implemented method of claim 1, wherein providing the representation of the virtual shelf composition as filled comprises transmitting, to the electronic device, the representation of the virtual shelf composition as filled, and wherein reception of the representation of the virtual shelf composition as filled by the electronic device causes the electronic device to display the representation of the virtual shelf composition as filled.

15. The computer-implemented method of claim 1, further comprising:
receiving, from the electronic device, an indication of detected user engagement with a particular media content item, wherein the particular media content item was present in the representation of the virtual shelf composition as filled; and
based on the indication of the detected user engagement, updating the respective likelihoods.

16. A computer-implemented method comprising:
determining a virtual shelf composition representing a distribution of content between a first content type and a second content type;
tuning the distribution of the virtual shelf composition based on an exploration process;
filling, in accordance with the distribution as tuned, the virtual shelf composition with a set of content of at least the first content type and the second content type; and
providing, for display on an electronic device, a representation of the virtual shelf composition as filled.

17. The computer-implemented method of claim 16, wherein the virtual shelf composition is based on one or more of, for a particular user: a time of day, a day of week, a content consumption history, a country, an age, or an account age.

18. The computer-implemented method of claim 16, wherein the first content type is one of music, podcasts, videos, or audiobooks, and wherein the second content type is one of music, podcasts, videos, or audiobooks, and wherein the first content type is different from the second content type.

19. A computer-implemented method comprising:
determining a plurality of virtual shelf compositions, wherein each of the virtual shelf compositions represents a different distribution of content between at least a first content type and a second content type;
determining, for each of the virtual shelf compositions, respective likelihoods of one or more user engagements with any of the content thereon;
selecting, from the plurality of virtual shelf compositions, a virtual shelf composition that has a highest of the respective likelihoods, wherein the virtual shelf composition has a respective distribution of content;
filling, in accordance with the respective distribution, the virtual shelf composition with a set of content of at least the first content type and the second content type; and
providing, for display on an electronic device, a representation of the virtual shelf composition as filled.

20. The computer-implemented method of claim 19, wherein the respective likelihoods of the one or more user engagements are based on the virtual shelf composition regardless of any particular content therein.
